(19) United States
(12) Patent Application Publication
(10) Pub. No.: US 2026/0023626 A1
(43) Pub. Date: Jan. 22, 2026

(54) MULTICORE PROCESSOR COMPUTER SYSTEM CONFIGURED TO ACTIVATE STATICALLY DEFINED TASKS, AND METHOD FOR MANAGING SUCH A MULTICORE PROCESSOR

(71) Applicant: Schaeffler Technologies AG & Co. KG, Herzogenaurach (DE)

(72) Inventors: Nicolas ROMEA, ST PIERRE-DE-LAGES (FR); Kevin MARTEIL, L'Union (FR)

(21) Appl. No.: 19/225,261

(22) Filed: Jun. 2, 2025

(30) Foreign Application Priority Data
Jul. 16, 2024 (FR) 2407771

(51) Int. Cl. G06F 9/52; G06F 9/50; G06F 15/80

(52) U.S. Cl. CPC G06F 9/52; G06F 9/5027; G06F 15/80

(57) ABSTRACT

The description relates to a method and a multicore processor computer system configured to activate statically defined tasks comprising at least one initiating task for initiating one or more asynchronous processing operations, and at least one set of identical implementation tasks that implement the one or the same asynchronous processing operations, and that are each allocated to a different core of the multicore processor. The initiating task activates the implementation tasks of a given set when a given asynchronous processing operation has to be initiated, and the implementation task of the given set that is ready first implements the given asynchronous processing operation, while the one or more other implementation tasks of the given set disregard the given asynchronous processing operation.

This allows the use of the cores to be optimized, and on execution allows dynamic selection of the core responsible for executing a given asynchronous processing operation, and therefore allows the pending time period to be reduced to a minimum.

### TECHNICAL FIELD

The present description relates to a multicore processor computer system configured to activate statically defined tasks. Such processors are used, for example, in on-board real-time systems, for example, in the automotive field.

### TECHNICAL BACKGROUND

Real-time systems must respond to events or execute tasks within predictable and strictly defined periods. Exceeding these periods can lead to critical failures. These constraints are particularly important in on-board systems, as in the automotive field.

In the automotive field, the operating systems that are used follow the German OSEK standard (“Offene Systeme und deren Schnittstellen für die Elektronik in Kraftfahrzeugen” (“Open Systems and their Interfaces for the Electronics in Motor Vehicles”)).

The OSEK standard specifies an operating system architecture, notably a structure for managing software tasks. In particular, it stipulates a static definition of the tasks, which means that the tasks must be defined in advance, when configuring the system, and cannot be created dynamically when being executed. In practice, all the tasks and their properties must be specified in a static configuration file before the system is deployed. The properties of a task notably include a priority permanently assigned to the task, an initial state of the task from among several possible states, as well as hardware and software resources required to execute the task.

Given the complexity of on-board systems, most of these systems use microcontrollers with a multicore processor, i.e., having several processing units that can be used simultaneously.

Various strategies can be implemented in order to distribute the processing operations of the tasks over the various cores of a multicore processor.

A requirement exists for optimizing these strategies in order to, on the one hand, improve the overall performance capabilities of the computer system, by making the best use of all the available cores, and, on the other hand, in order to reduce the pending time of the tasks before they are executed.

### SUMMARY

A first aspect of the present description relates to a multicore processor computer system configured to activate statically defined tasks. In the computer system described herein, said tasks include: at least one initiating task, configured to initiate one or more processing operations, including one or more asynchronous processing operations, and at least one set of implementation tasks, including at least two implementation tasks configured to implement the one or the same asynchronous processing operations, and each allocated to a different core of the multicore processor. The initiating task is configured to activate the implementation tasks of a given set of implementation tasks when a given asynchronous processing operation has to be initiated, and the implementation tasks are configured such that the implementation task of the given set of implementation tasks that is ready first implements the given asynchronous processing operation, while the one or more other implementation tasks of the given set of implementation tasks disregard the given asynchronous processing operation.

In one embodiment, each of the initiating and implementation tasks is allocated to a different core of the multicore processor.

In one embodiment, the initiating task is configured to generate a request to initiate the given asynchronous processing operation, and the implementation tasks are configured to verify, before implementing the given asynchronous processing operation, that a request exists for initiating the given asynchronous processing operation pending execution.

In one embodiment, the initiating and implementation tasks are configured to manage information representing a number of initiation requests pending execution for each asynchronous processing operation, with said information being updated, on the one hand, by the initiating task when it initiates a given asynchronous processing operation in order to increment the number of initiation requests pending execution for the given asynchronous processing operation, and, on the other hand, by the implementation tasks when they implement the given asynchronous processing operation in order to decrement the number of initiation requests pending execution for the given asynchronous processing operation.

In one embodiment, the computer system comprises a single set of implementation tasks configured to implement all the one or more asynchronous processing operations associated with said at least one initiating task. In an alternative embodiment, the computer system comprises several sets of implementation tasks configured to together implement all the one or more asynchronous processing operations associated with said at least one initiating task. For example, each implementation task of the same set is associated with the same automotive safety integrity level, which is different from at least one other automotive safety integrity level associated with the implementation tasks of at least one other set of implementation tasks. For example, the computer system comprises a first and a second set of implementation tasks, with the implementation tasks of the first set of implementation tasks being configured to implement at least one asynchronous processing operation associated with a first automotive safety integrity level, and the implementation tasks of the second set of implementation tasks being configured to implement at least one asynchronous processing operation associated with a second automotive safety integrity level different from the first level.

A second aspect of the present description relates to a method for managing a multicore processor configured to execute statically defined tasks. In the method described herein, said tasks include at least one initiating task, configured to initiate one or more processing operations including one or more asynchronous processing operations, and at least one set of implementation tasks, including at least two implementation tasks configured to implement the one or the same asynchronous processing operations, and each allocated to a different core of the multicore processor. The method includes the following steps: when a given asynchronous processing operation has to be implemented, each of the implementation tasks of a given set of implementation tasks is activated by the initiating task; furthermore, the given asynchronous processing operation is implemented by the implementation task of the given set of implementation tasks that is first ready to implement it, with the other implementation tasks disregarding the given asynchronous processing operation.

In one embodiment, each of the initiating and implementation tasks is allocated to a different core of the multicore processor.

In one embodiment, the method for managing a multicore processor comprises the initiating task generating a request to initiate the given asynchronous processing operation, and the implementation tasks verifying, before implementing a given asynchronous processing operation, that a request exists for initiating the given asynchronous processing operation pending execution.

In one embodiment, the method for managing a multicore processor comprises, when the initiating task initiates a given asynchronous processing operation, the initiating task updating information representing a number of initiation requests pending execution for each asynchronous processing operation, in order to increment the number of initiation requests pending execution for the given asynchronous processing operation, and, when a given implementation tasks implements the given asynchronous processing operation, the given implementation task updating said information in order to decrement the number of initiation requests pending execution for the given asynchronous processing operation.

In one embodiment of the method for managing a multicore processor, a single set of implementation tasks is configured to together implement all the one or more asynchronous processing operations associated with said at least one initiating task. In an alternative embodiment, several sets of implementation tasks are configured to together implement all the one or more asynchronous processing operations associated with said at least one initiating task. In other words, the implementation tasks of the one or more sets of implementation tasks are configured to together implement all the one or more asynchronous processing operations associated with said at least one initiating task.

For example, each implementation task of the same set is associated with the same automotive safety integrity level, which is different from at least one other automotive safety integrity level associated with the implementation tasks of at least one other set of implementation tasks. For example, a first and a second set of implementation tasks are configured, with the implementation tasks of the first set of implementation tasks being configured to implement at least one asynchronous processing operation associated with a first automotive safety integrity level, and the implementation tasks of the second set of implementation tasks being configured to implement at least one asynchronous processing operation associated with a second automotive safety integrity level different from the first level.

A third aspect of the present description relates to a computer program comprising instructions for implementing a method for managing a multicore processor as described above, when it is executed by a processor.

A fourth aspect of the present description relates to a motor vehicle comprising a multicore processor computer system as described above.

In the scheduling strategy described herein, main tasks are implemented by a first core, whereas other tasks, which do not have to be synchronized with these main tasks, are entrusted to one or more other cores, thus optimizing the use of the various cores of the processor. For example, this allows any highly charged cores to be discharged and/or allows any cores that are seldom or never used to be used.

When a new task is activated, it begins to be executed after a certain period, called pending period, which depends on the other tasks that are currently running or are pending execution on the same core and on their priority with respect to that of the new task.

The system and the method described herein comprise several implementation tasks, allocated to different cores and configured to implement the same asynchronous processing operation. When the asynchronous processing operation is initiated by an initiating task, all the corresponding implementation tasks are activated. Furthermore, the asynchronous processing operation is implemented by those tasks of the implementation tasks that are ready first.

The solution that is described allows dynamic selection, on execution, of the core responsible for executing a given asynchronous processing operation, even though the tasks are statically defined. This allows the pending period to be reduced to a minimum.

The initiating task that is configured to initiate the asynchronous processing operation can be associated with a single set or with several sets of implementation tasks. When a single set is used, the tasks of this set are configured to implement all the asynchronous processing operations associated with the initiating task. When several sets are used, the sets taken as a whole must allow all the asynchronous processing operations associated with the initiating task to be implemented. However, it is possible that the implementation tasks of a set, taken in isolation, can only implement some of the asynchronous processing operations linked to the initiating task. The use of several sets allows, for example, specific requirements to be managed that are linked to certain asynchronous processing operations. For example, in the automotive field, asynchronous processing operations linked to the safety functions of a vehicle may need to be executed by dedicated tasks with specific properties. In this case, a set of implementation tasks dedicated to the security function is advantageously used, and another set of implementation tasks dedicated to the other functions is used.

### BRIEF DESCRIPTION OF THE FIGURES

Further features and advantages of the invention will become apparent upon reading the following detailed description, which will be more clearly understood with reference to the appended drawings, in which:

FIG. 1 shows a diagram of the states of a task of a computer system as described herein;

FIG. 2 is a diagram showing the operation of a task in a computer system as described herein;

FIG. 3 is a flowchart showing an example of steps implemented by the initiating tasks;

FIG. 4 is a flowchart showing an example of steps implemented by the implementation tasks;

FIG. 5 is a diagram showing a first embodiment, with a single set of implementation tasks;

FIG. 6 is a diagram showing a second embodiment, with two sets of implementation tasks.

### DETAILED DESCRIPTION

In the following description, identical, similar or analogous elements will be denoted using the same reference signs.

The present description relates to a multicore processor computer system and proposes a strategy for scheduling tasks allowing an asynchronous processing operation to be executed by a core other than the core that executes the task initiating the asynchronous processing operation.

Without being limiting, it is applicable, for example, in the automotive field. For example, a system for controlling a vehicle is configured to acquire input data from the vehicle, for example, via sensors, and to implement processing operations on the acquired data in order to define a reaction of the vehicle (braking, changing trajectory, etc.). These processing operations are generally implemented according to a sequence to be followed. These are then referred to as synchronous processing operations. The vehicle also implements processing operations that can be executed independently without requiring a strict execution order or a restricting waiting period. This is the case, for example, for processing operations intended to diagnose the state of the vehicle. These are then referred to as asynchronous processing operations.

The present description applies to a multicore processor computer system, in which the tasks are statically defined, i.e., when configuring the system. The tasks are configured to invoke executable instructions stored in a non-volatile memory and that allow processing operations to be implemented when they are executed by a core of the multicore processor. The tasks have properties that are set in a static configuration file before the system is deployed. The properties of a task notably include a priority permanently assigned to the task, an initial state of the task from among several possible states, as well as hardware and software resources required to execute the task.

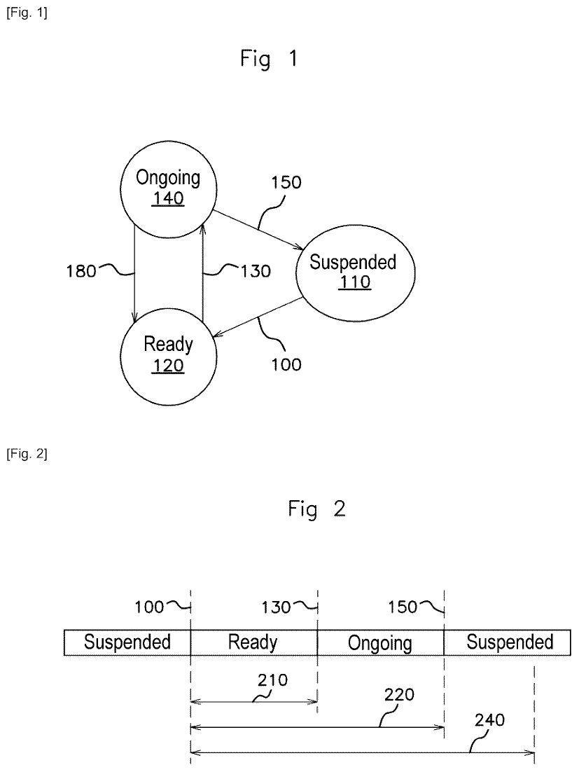

Conventionally, the system guarantees the order of execution of the tasks by using a fixed-priority arbitration mechanism. As shown in FIG. 1, a task can have several states, notably: “suspended”, “ready” or “ongoing”. When a task is activated (step 100), it transitions from the “suspended” state 110 to the “ready” state 120. However, the task is not executed immediately: it must wait for the highest priority tasks to be completed. The task is then started (step 130) and transitions to the “ongoing” state 140, during which it is executed. When the execution is complete, the task returns to the “suspended” state 110 (step 150). In some systems, a higher priority task can interrupt a lower priority task, using a mechanism called pre-emption and shown in FIG. 1 by an arrow 180 transitioning from the “ongoing” state 140 to the “ready” state 120.

As illustrated in FIG. 2, a task in the “suspended” state 110 transitions to the “ready” state 120 following an activation 100. It then waits for a period 210, called pending time, before transitioning to the “ongoing” state 140. The time 220 that elapses between the activation 100 and the end of the execution 150 is called the response time. The time constraint to be followed for executing the task is called a deadline and is referenced 240 in FIG. 2. In a real-time system, the response time 220 must be shorter than the deadline 240 in order to comply with real-time constraints.

The pending time 210 before beginning to execute the task depends on several parameters, notably: the execution time of the ongoing task, the scheduling strategy used (for example, the use of pre-empting mechanisms by the highest-priority tasks), any other tasks with higher priority that have already been activated, which are in the “ready” state, with external stimuli. The response time 220 of the task is therefore directly dependent on the other tasks that are ready or are being executed on the same core. This can result in non-compliance with the deadline and therefore in non-compliance with the real-time constraints of the system.

It is therefore important to minimize the pending time 210 of the implementation task that will implement an asynchronous processing operation.

In the system and the method described herein, at least one initiating task is defined for initiating one or more processing operations, including one or more asynchronous processing operations, as well as at least one set of a plurality of implementation tasks configured to implement the one or the same asynchronous processing operations, with each of said implementation tasks of the same set being allocated to a different core of the multicore processor. The initiating task is configured to activate all the implementation tasks of a given set when a given asynchronous processing operation has to be initiated, and the implementation tasks are configured such that the implementation task of the given set that is ready first implements the given asynchronous processing operation, while the one or more other implementation tasks of the given set disregard the given asynchronous processing operation.

Although the tasks are statically defined, the core that offers the shortest pending time thus can be dynamically selected at the time of execution.

For a given initiating task, the implementation tasks are said to be identical because they invoke the one or the same executable instructions that are stored in a non-volatile memory and that are executed by the core on which the implementation task is launched (one or more executable instructions per asynchronous processing operation associated with the initiating task).

Advantageously, the initiating task is allocated to a core other than the cores allocated to the implementation tasks that are associated therewith.

When a single set is configured, each implementation task of the set is configured to implement all the asynchronous processing operations associated with the one or more initiating tasks liable to activate it.

When several sets are configured, the sets taken as a whole must be able to implement all the asynchronous processing operations associated with the one or more initiating tasks. For example, the implementation tasks can be divided into two groups according to a given criterion (for example, the type of processing). A first set can be configured to implement the processing operations of the first group and a second set can be configured to implement the processing operations of the second group. For example, in the automotive field, the criterion can be the

Automotive Safety Integrity Level (ASIL, which is a classification defined by the ISO 26262 standard that determines the risk level associated with a safety failure in motor vehicle systems).

As indicated above, the initiating task is configured to activate all the implementation tasks of a given set when a given asynchronous processing operation has to be initiated, and the implementation tasks are configured such that the implementation task of the given set that is ready first implements the given asynchronous processing operation, while the one or more other implementation tasks of the given set disregard the given asynchronous processing operation.

For example, the initiating task is configured to generate a request to initiate the given asynchronous processing operation, and the implementation tasks are configured to verify, before implementing the given asynchronous processing operation, that a request exists for initiating the given asynchronous processing operation pending execution. The initiating and implementation tasks are then configured, for example, to manage information representing a number of initiation requests pending execution for each asynchronous processing operation. The information concerning the number of requests is updated by the initiating task when it initiates a given asynchronous processing operation in order to increment the number of initiation requests pending execution for the given asynchronous processing operation. Furthermore, it is updated by the implementation tasks when they implement the given asynchronous processing operation in order to decrement the number of initiation requests pending execution for the given asynchronous processing operation.

In a first embodiment, the information concerning the number of requests includes a flag and therefore allows a binary indication to be provided as to whether an initiation request is pending execution for a given asynchronous processing operation. In a second embodiment, the information concerning the number of requests includes a counter and then allows a plurality of initiation requests pending execution to be managed for the same given asynchronous processing operation. In a third embodiment, the information concerning the number of requests includes a table and thus allows a plurality of initiation requests pending execution to be managed for a plurality of given asynchronous processing operations. Indeed, an initiating task can generate a second initiation request for the same asynchronous processing operation, while the first request has not yet been executed. Moreover, an initiating task can generate an initiation request for an asynchronous processing operation while an initiation request has already been generated by another initiating task for the same asynchronous processing operation. Moreover, one or more initiating tasks can generate an initiation request for various asynchronous processing operations without the previous processing operations being completed.

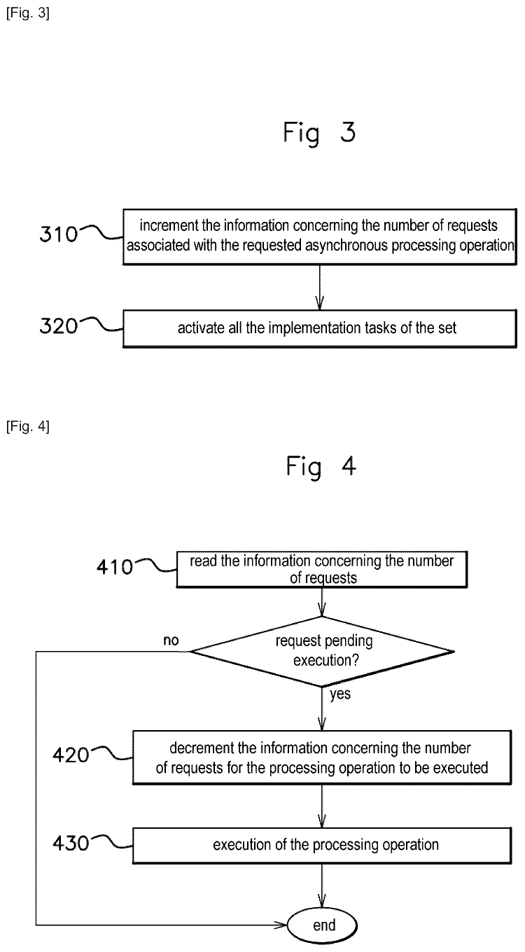

FIG. 3 shows the steps implemented by any initiating task, i.e., any task liable to request the execution of an asynchronous processing operation. In step 310, the initiating task increments the information concerning the number of requests (i.e., the flag, the counter or the table in the example described above) in order to request a new execution of the asynchronous processing operation. In step 320, it activates all the implementation tasks of a given set of implementation tasks. FIG. 4 shows the steps implemented in any implementation task, i.e., any task liable to implement the requested asynchronous processing operation. In step 410, the implementation task is in the “ongoing” state. It reads the information concerning the number of requests to check that an initiation request exists for an asynchronous processing operation pending execution. If one exists (active flag, positive counter, positive value in a cell of the table in the example described above), then, in step 420, the implementation task is set to execute this request by decrementing the corresponding information concerning the number of requests.

Next, in step 430, the implementation task then executes the asynchronous processing operation. If, on the contrary, there is no initiation request pending execution, the implementation task ends without doing anything.

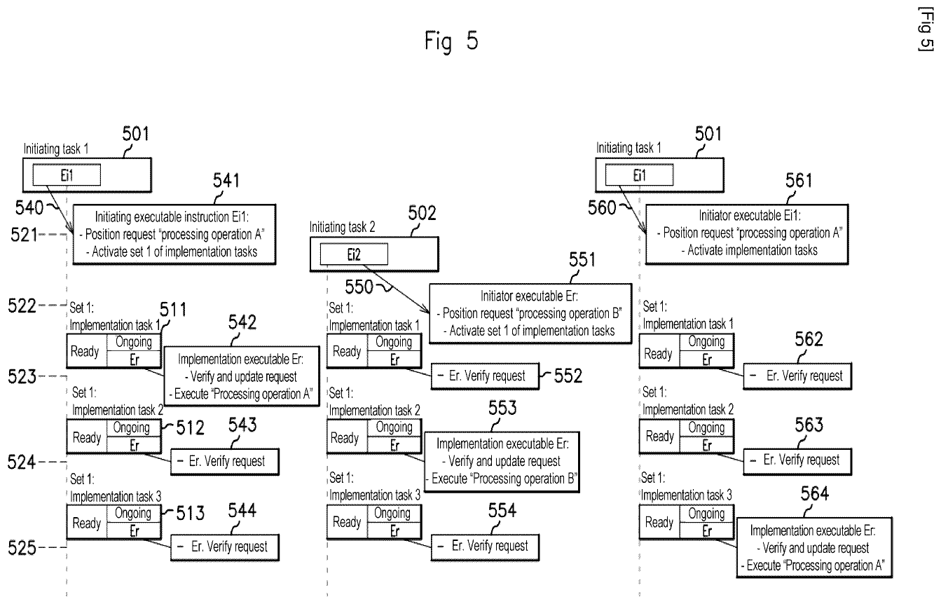

FIG. 5 is a diagram describing a first embodiment with two initiating tasks 501 and 502 associated with a single set of three implementation tasks 511, 512 and 513. The initiating task 501 is configured to initiate an asynchronous processing operation T1. The initiating task 502 is configured to initiate an asynchronous processing operation T2. The three implementation tasks 511, 512 and 513 invoke the same executable instruction ER that is capable of implementing the two asynchronous processing operations T1 and T2. The executable instructions that implement the processing operations of the first and of the second initiating task 501 and 502 are referenced EI1 and EI2, respectively.

The first and the second initiating task 501 and 502 are allocated to a first and to a second core 521 and 522, respectively, of the multicore processor. The three implementation tasks 511, 512 and 513 are allocated to a third, a fourth and a fifth core of the multicore processor, respectively, referenced 523, 524 and 525.

As illustrated in FIG. 5, in step 540, the initiating task 501 invokes the executable instruction EI1 in order to initiate the asynchronous processing operation T1. An instance 541 of the executable instruction EI1 increments the information concerning the number of requests relating to the asynchronous processing operation T1 and activates the set of implementation tasks 511, 512 and 513. In the example described in FIG. 5, the implementation task 511 is ready first. It therefore invokes the executable instruction ER. An instance 542 of the executable instruction ER verifies the information concerning the number of requests, observes that the asynchronous processing operation T1 is pending execution, decrements the information concerning the number of requests corresponding to the processing operation T1, and executes the processing operation T1. When the implementation tasks 512 and 513 are ready in turn, they invoke the executable instruction ER. Two new instances of the executable instruction ER, referenced 543 and 544, respectively, verify the information concerning the number of requests, and observe that no asynchronous processing operation is pending execution and terminate.

In step 550, the initiating task 502 invokes the executable instruction E12 to initiate the asynchronous processing operation T2. An instance 551 of the executable instruction EI1 increments the information concerning the number of requests relating to the asynchronous processing operation T2 and activates the set of implementation tasks 511, 512 and 513. The implementation task 512 is ready first. It therefore invokes the executable instruction ER. An instance 553 of the executable instruction ER verifies the information concerning the number of requests, observes that the asynchronous processing operation T2 is pending execution, decrements the information concerning the number of requests corresponding to the processing operation T2, and executes the processing operation T2. When the implementation tasks 511 and 513 are ready in turn, they invoke the executable instruction ER. Two new instances of the executable function ER, referenced 552 and 554, respectively, verify the information concerning the number of requests, and observe that no asynchronous processing operation is pending execution (the processing operation T1 has been executed by the implementation task 511 and the processing operation T2 has been executed or is currently being executed by the implementation task 512) and terminates.

In step 560, the initiating task 501 invokes the executable instruction EI1 again in order to initiate the asynchronous processing operation T1. An instance 561 of the executable instruction EI1 increments the information concerning the number of requests relating to the asynchronous processing operation T1 and activates the set of implementation tasks 511, 512 and 513. The implementation task 513 is ready first. It therefore invokes the executable instruction ER. An instance 564 of the executable instruction ER verifies the information concerning the number of requests, observes that the asynchronous processing operation T1 is pending execution, decrements the information concerning the number of requests corresponding to the processing operation T1, and executes the processing operation T1. When the implementation tasks 511 and 512 are ready in turn, they invoke the executable instruction ER. Two new instances of the executable instruction ER, referenced 562 and 563, respectively, verify the information concerning the number of requests, and observe that no asynchronous processing operation is pending execution and terminate.

In the example of FIG. 5, the information concerning the number of requests is a table [n1; n2], where n1 is the number of ongoing requests for the asynchronous processing operation T1 and n2 is the number of ongoing requests for for the asynchronous processing operation T2. The executable instruction EI1 increments the value of n1, the executable instruction EI2 increments the value of n2, and the executable instruction ER decrements the value of n1 before implementing the processing operation T1 and the value of n2 before implementing the processing operation T2.

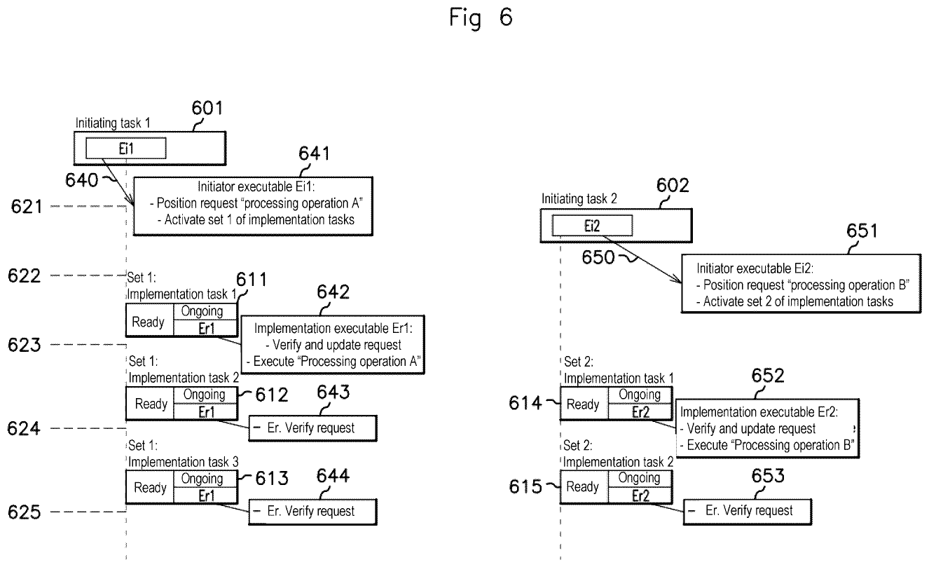

FIG. 6 is a diagram describing a second embodiment with two initiating tasks 601 and 602. The initiating task 601 is configured to initiate an asynchronous processing operation T1 and it is associated with a first set 606 of three implementation tasks 611, 612 and 613. The initiating task 602 is configured to initiate an asynchronous processing operation T2 and it is associated with a second set 608 of two implementation tasks 614 and 615. The three implementation tasks 611, 612 and 613 invoke the same executable instruction ER1 that is capable of implementing the asynchronous processing operation T1.

The two implementation tasks 614 and 615 invoke the same executable instruction ER2 that is capable of implementing the asynchronous processing operation T2.

The executable instructions that implement the processing operations of the first and of the second initiating task 601 and 602 are referenced EI1 and E12 in FIG. 6, respectively.

The first and the second initiating task 601 and 602 are allocated to a first and to a second core 621 and 622, respectively, of the multicore processor. The implementation task 611 is allocated to a third core 623 of the multicore processor.

The two implementation tasks 612 and 614 are allocated to a fourth core 624 of the multicore processor. Furthermore, the two implementation tasks 613 and 615 are allocated to a fifth core 625 of the multicore processor.

As illustrated in FIG. 6, in step 640, the initiating task 601 invokes the executable instruction EI1 in order to initiate the asynchronous processing operation T1. An instance 641 of the executable instruction EI1 increments the information concerning the number of requests relating to the asynchronous processing operation T1, and activates the implementation tasks 611, 612 and 613 of the first set of implementation tasks 606. In the example described in FIG. 6, the implementation task 611 is ready first. It therefore invokes the executable instruction ER1. An instance 642 of the executable instruction ER1 verifies the information concerning the number of requests, observes that the asynchronous processing operation T1 is pending execution, decrements the number of requests corresponding to the processing operation T1, and executes the processing operation T1. When the implementation tasks 612 and 613 are ready in turn, they invoke the executable instruction ER1. Two new instances of the executable instruction ER1, referenced 643 and 644, respectively, verify the information concerning the number of requests, and observe that no asynchronous processing operation is pending execution and terminate.

In step 650, the initiating task 602 invokes the executable instruction EI2 to initiate the asynchronous processing operation T2. An instance 651 of the executable instruction EI2 increments the information concerning the number of requests relating to the asynchronous processing operation T2, and activates the implementation tasks 614 and 615 of the second set of implementation tasks 608.

The implementation task 614 is ready first. It therefore invokes the executable instruction ER2. An instance 652 of the executable instruction ER2 verifies the information concerning the number of requests, observes that the asynchronous processing operation T2 is pending execution, decrements the number of requests corresponding to the processing operation T2, and executes the processing operation T2. When the implementation task 615 is ready in turn, it invokes the executable instruction ER2. A new instance 653 of the executable instruction ER2 verifies the information concerning the number of requests, and observes that no asynchronous processing operation is pending execution (the processing operation T1 has been executed by the implementation task 611 and the processing operation T2 has been executed or is currently being executed by the implementation task 614) and terminates.

In the example of FIG. 6, the information concerning the number of requests is a table [n1; n2], where n1 is the number of ongoing requests for the asynchronous processing operation T1 and n2 is the number of ongoing requests for the asynchronous processing operation T2. The executable instruction EI1 increments the value of n1, the executable instruction EI2 increments the value of n2, the executable instruction ER1 decrements the value of n1 before executing the processing operation T1, and the executable instruction ER2 decrements the value of n2 before executing the processing operation T2.

The functional diagrams shown herein show conceptual views that are provided by way of a non-limiting example for illustrating the principles of the present disclosure. These principles can be implemented in devices with multiple variants.

The sole purpose of the terminology used herein is to describe particular embodiments and is not limiting.

Notably, the terms “comprises”, “comprising”, “includes” and/or “including” specify the presence of given features, steps, operations, elements and/or components, but do not exclude the presence or the addition of one or more other features, steps, operations, elements or components.

1. A multicore processor computer system configured to activate statically defined tasks, said tasks comprising:
at least one initiating task (501, 601, 602) configured to initiate one or more processing operations, including one or more asynchronous processing operations; and
at least one set of implementation tasks (511, 512, 513, 611, 612, 613, 614, 615), comprising at least two implementation tasks configured to implement the one or the same asynchronous processing operations;
and each allocated to a different core of the multicore processor;
the initiating task being configured to activate the implementation tasks of a given set of implementation tasks when a given asynchronous processing operation has to be initiated (310, 320), and the implementation tasks being configured such that the implementation task of the given set of implementation tasks that is ready first implements the given asynchronous processing operation, while the one or more other implementation tasks of the given set of implementation tasks disregard the given asynchronous processing operation (410, 420, 430, 440).

2. The multicore processor computer system as claimed in claim 1, characterized in that each of the initiating (501, 601, 602) and implementation (511, 512, 513, 611, 612, 613, 614, 615) tasks is allocated to a different core of the multicore processor.

3. The multicore processor computer system as claimed in claim 1, characterized in that it comprises a single set of implementation tasks (511, 512, 513) configured to implement all the one or more asynchronous processing operations associated with said at least one initiating task.

4. The multicore processor computer system as claimed in claim 1, characterized in that it comprises a plurality of sets of implementation tasks (611, 612, 613 and 614, 615), configured to together implement all the one or more asynchronous processing operations associated with said at least one initiating task (601, 602).

5. The multicore processor computer system as claimed in claim 4, characterized in that each implementation task (611, 612, 613 and 614, 615) of the same set is associated with the same automotive safety integrity level, different from at least one other automotive safety integrity level associated with the implementation tasks (614, 615 and 611, 612, 613) of at least one other set of implementation tasks.

6. The multicore processor computer system as claimed in claim 5, characterized in that it comprises a first (611, 612, 613) and a second (614, 615) set of implementation tasks, with the implementation tasks of the first set of implementation tasks (611, 612, 613) being configured to implement at least one asynchronous processing operation associated with a first automotive safety integrity level, and the implementation tasks of the second set of implementation tasks (614, 615) being configured to implement at least one asynchronous processing operation associated with a second automotive safety integrity level different from the first level.

7. The multicore processor computer system as claimed in claim 1, characterized in that the initiating task (501, 601, 602) is configured to generate a request to initiate the given asynchronous processing operation, and the implementation tasks are configured to verify, before implementing the given asynchronous processing operation, that a request exists for initiating the given asynchronous processing operation pending execution (410).

8. The multicore processor computer system as claimed in claim 1, characterized in that the initiating (501, 601, 602) and the implementation (611, 612, 613 and 614, 615) tasks are configured to manage information representing a number of initiation requests pending execution for each asynchronous processing operation, with said information being updated, on the one hand, by the initiating task when it initiates a given asynchronous processing operation in order to increment the number of initiation requests pending execution for the given asynchronous processing operation (310), and, on the other hand, by the implementation tasks when they implement the given asynchronous processing operation in order to decrement the number of initiation requests pending execution for the given asynchronous processing operation (420).

9. A method for managing a multicore processor configured to execute statically defined tasks, with said tasks comprising at least one initiating task (501, 601, 602) configured to initiate one or more processing operations, including one or more asynchronous processing operations, and at least one set of implementation tasks (611, 612, 613, and 614, 615) comprising at least two implementation tasks configured to implement the one or the same asynchronous processing operations, and each allocated to a different core of the multicore processor, said method comprising the following steps:
when a given asynchronous processing operation has to be implemented, the initiating task activating (320) each of the implementation tasks of a given set of implementation tasks;
implementing (430) the given asynchronous processing operation using the implementation tasks of the given set of implementation tasks that is first ready to implement it, with the other implementation tasks disregarding the given asynchronous processing operation.

10. The method as claimed in claim 9, characterized in that each of the initiating (501, 601, 602) and implementation (611, 612, 613 and 614, 615) tasks is allocated to a different core of the multicore processor.

11. The method as claimed in claim 9, wherein the implementation tasks (611, 612, 613 and 614, 615) of the one or more sets of implementation tasks are configured to together implement all the one or more asynchronous processing operations associated with said at least one initiating task.

12. The method as claimed in claim 9, characterized in that it comprises the initiating task (501, 601, 602) generating a request to initiate the given asynchronous processing operation, and the implementation tasks (611, 612, 613 and 614, 615) verifying, before implementing a given asynchronous processing operation, that a request exists for initiating the given asynchronous processing operation pending execution.

13. The method as claimed in claim 9, characterized in that it comprises:
when the initiating task initiates a given asynchronous processing operation, the initiating task updating information representing a number of initiation requests pending execution for each asynchronous processing operation, in order to increment the number of initiating requests pending execution for the given asynchronous processing operation (310);
when a given implementation task implements the given asynchronous processing operation, the given implementation task updating said information in order to decrement the number of initiation requests pending execution for the given asynchronous processing operation (420).

14. A computer program comprising instructions for implementing a method as claimed in claim 9 when this program is executed by a processor.

15. A motor vehicle including a multicore processor computer system as claimed in claim 1.
